(19) United States
(12) Patent Application Publication
(10) Pub. No.: US 2001/0035468 A1
(43) Pub. Date: Nov. 1, 2001

(54) Portable accelerated growth system for vegetation

(76) Inventors: Cathy D. Santa Cruz, Reno, NV (US); Gordon E. Churchward, Silver City, NV (US)

Correspondence Address: Cathy D. Santa Cruz, 7630 Tholl Drive, Reno, NV, 89506, US

(21) Appl. No.: 09/814,293

(22) Filed: Mar. 20, 2001

Related U.S. Application Data
(60) Provisional application No. 60/190,645, filed on Mar. 20, 2000.

(51) Int. Cl. B05B 3/00

(52) U.S. Cl. 239/726; 239/735; 239/742; 239/723

(57) ABSTRACT

A portable or stationary system which may be used either indoors or outdoors and provides accelerated growth of vegetation regardless of weather conditions as well as provides warmth, lighting, misting, nutrients and cover for such vegetation.

### FIELD OF THE INVENTION

This invention is responsive to our provisional application No. 60/190645 filed on Mar. 20, 2000 and relates to a year round growing system for vegetation in general, but more particularly relates to an apparatus which may be used either indoors or outdoors and provides accelerated growth of grass, plants, etc., regardless of weather conditions. The system further provides warmth, lighting, misting, nutrients and cover for areas of parks, golf courses, acreages, sports fields, stadiums, arenas, school yards, etc., which utilize grass, sod, or other vegetation. This system is also usable 24 hours a day, night or day. The system is economical to manufacture, it may be portable or stationary, motorized or manual, and is mounted on a movable structure which provides overall coverage of designated areas.

### BACKGROUND OF THE INVENTION

Within the prior art portable irrigation systems are well know and many variants have been taught with each having different characteristics. However each have inherent disadvantages that the present invention addresses and eliminates in a manner heretofore not taught.

For example, U.S Pat. No. 5,070,643 “METHOD AND COVER FOR GRASS PROTECTION AND RESTORATION AND FOR SEED GERMINATION” is limited in use for several reasons. Such as the scope of this invention addresses only the covering of grassy areas, but, does not identify or acknowledge the problem of providing moisture and warmth and light for growth. It does permit the passage of air and moisture through the open weave of the covering, but, simply overlooks the need for proper grow lights and misting of vegetation to facilitate fast growing sod.

Portable irrigation systems are well known in the prior art such as disclosed in U.S. Pat. No. 5,447,274 “PORTABLE IRRIGATION APPARATUS USING PUMPED OR DIRECT WATER” and specifically addresses the need for water to be supplied to large areas of land in a portable manner. This embodiment does not however take into consideration the advantages which could be achieved by supplying nutrients at the same time as providing water and/or moisture. These same disadvantages can be noted in other patents cited in this field such as U.S. Pat. No. 4,865,255 and U.S. Pat. No. 4,848,832.

Self-propelled irrigation systems are in wide use throughout various parts of the world to supplement inadequate rainfall and to provide the necessary supply of water to grow vegetation. The prior art identified, such as U.S. Pat. No. 5,678,771 for example does not provide in combination the various advantages such as lighting, warmth, etc., that is being addressed in our application.

In addition to the disadvantages previously mentioned, no where in the prior art is the height of the distribution system adjustable, which would allow the vegetation to receive the proper amount of heat and light generated from the grow lights.

### SUMMARY OF THE INVENTION

A primary object of the present invention is to provide a system which will enable the continued and rapid growth of sod and/or vegetation all year long, either indoors or outdoors, 24 hours a day, night or day.

Another object of the present invention is to provide grow lights that will be individually adjustable in height so as to allow the degree of warmth and light provided by the grow lights to vary according to the desires of the end user.

Yet another object of the present invention is to allow the system to be either manually operated, automated, motorized, stationary, or portable, so as to easily move across large areas of designated fields.

It is a further object of the present invention to provide a growth system which could be solar powered in order to be environmentally friendly, or the system can be battery operated, and/or a combination of solar power and batteries.

Yet another object of the present invention, is to provide a growth system that will provide a cover for grass and vegetation and protection year round, either day or night, or 24 hours a day, and is unaffected by weather conditions.

It is a further object herein to provide an economical method for providing moisture and nutrients to identified vegetation where rapid or accelerated growth is desired.

An additional object of the present invention is to provide a lightweight, easily transportable and storable growth system which can be reused throughout the year.

These and other objects and advantages of the present invention will be seen when taken into consideration with the accompanying drawings specification.

### BRIEF DESCRIPTION OF THE DRAWINGS

FIG. 1 is substantially a side view of the present invention.

FIG. 2 is substantially a top view of the present invention.

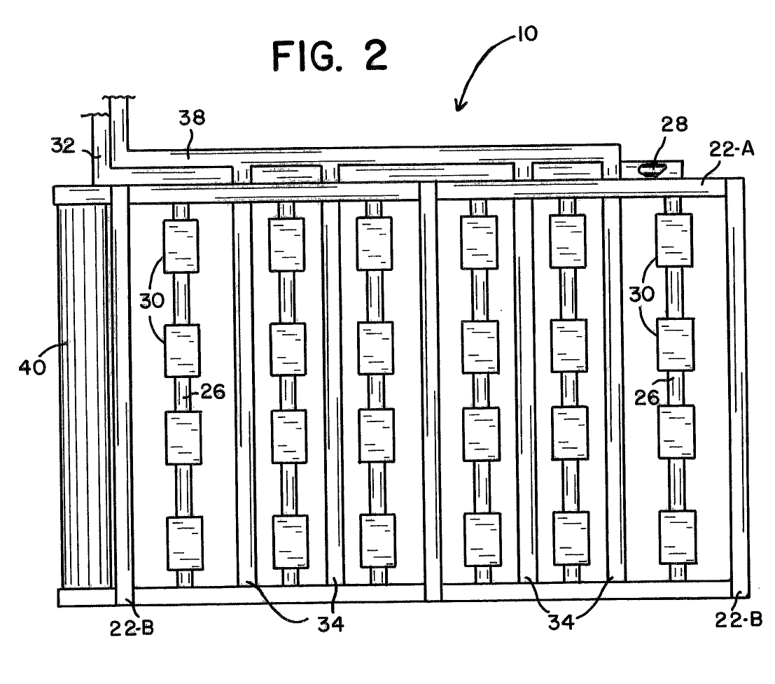

### DETAILED DESCRIPTION OF THE DRAWINGS

Referring now in detail to the drawings wherein like characters refer to like elements through out the various views.

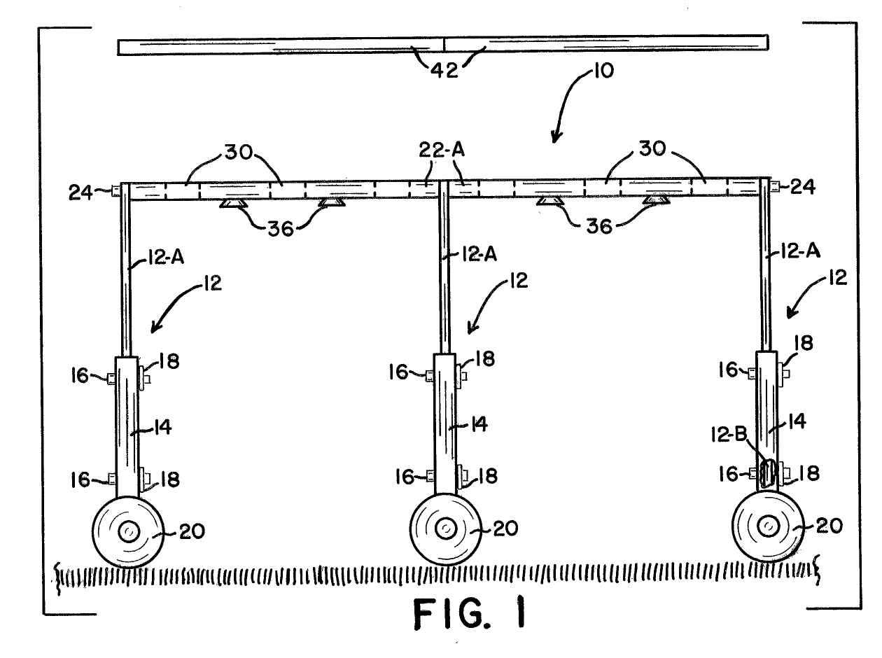

As illustrated in FIGS 1 & 2, (10) is substantially an overview of the present invention which is an accelerated growth system for vegetation. The system (10) can be used for year round growing purposes, 24 hours a day, day or night, either indoors or outdoors, and can be utilized for substantially any type of vegetation of user choice. For example, this system can be used for continuous maintenance for growing sod such as on football fields, or it can be used for vegetables, etc.

It is to be noted the system may include many different types of embodiments, such as the overall framework may be in the shape of a triangle, square, circle, etc. However the preferred embodiment is depicted in FIGS. 1 & 2. Wherein the accelerated growth system includes multiple upright support legs (12) which may be integrally formed as one part, or they may be formed from a top section (12-A) and a bottom section (12-B). Each of the sections (12-A & 12-B) being slidably engaged within a support leg housing (14) and each section (12-A & 12-B) and support leg housing (14) are removably adjustably attached together by suitable attachment means of engineering choice, such as by bolts (16) and washers (18). However, other attachment means is to include threads, screws, nuts, etc. Thus, support legs (12) are variably adjustable in height into a position of user choice. This allows for the system (10) to be versatile and usable with different types of crops having various heights or individual requirements.

Each bottom section (12-B) being fixedly attached to a typical prior art wheel assembly (20) by suitable attachment means of engineering choice, (not shown) as wheels of the suitable type are well known. It is to be understood that other types of ground engagement means may be utilized, for example if the system (10) is to be stationary, then spikes, discs, or tripods may be more appropriate. Also, it is to be noted that the wheels (20) can be mounted in different positions of engineering choice.

Each of the multiple legs (12) are removably yet fixedly attached to horizontal support beams (22) by any suitable attachment means of engineering choice, such as by bolts (24) and washers (not shown), threads, screws, etc.

Each of the horizontal support beams (22) are interconnected into different configurations depending upon user choice, such as to form substantially a rectangular shaped framework, as illustrated herein, comprising side horizontal support beams (22-A) and cross horizontal support beams (22-B) being removably interconnected together. It is to be understood if so desired, each of the interconnecting beams (22-A & 22-B) may also be pivotably interconnected and attached, so as to allow for various configurations to be easily achieved.

Each of the cross horizontal support beams (22-B) are removably yet fixedly attached to multiple light support members (26) by suitable attachment means of choice. Such as each of the cross horizontal support beams (22-B) may include apertures (not shown) for slidably receiving a light support member (26) there through and multiple light support members (26) are fixedly attached in place by bolts and nuts, (not shown), or the like. Also, multiple light support members (26) are of a shape and size to contain an electrical conduit (28) therein, for electrically connecting in series multiple grow lights (30). With each of the multiple light support members (26) being connected to an elongated electrical conduit housing (32) which further supports conduit (28). With conduit (28) being electrically connected to an external power source of user choice. It is to be noted other types of sealed compartments for containment of the conduit (28), such as an external sealed electrical compartment may be used, depending on engineering choice.

It is to be noted any suitable type of grow lights (30) may be used according to engineering choice, and each of the grow lights (30) may be removably yet fixedly attached to multiple light support members (26) by any suitable attachment means of choice, such as threaded light receptacles (not shown), or the like. It is to be further noted that each of the grow lights (30) should be rotateably mounted so as to allow the user to direct the lights (30) in various directions according to their needs. Also, grow lights (30) may include individual variable adjustable height means, thus if the terrain is uneven, each light (30) may be individually lowered or raised, depending on user needs.

Each of the cross horizontal support beams (22-B) are further removably yet fixedly attached to multiple sprinkler support members (34) by suitable attachment means of choice. Such as each of the cross horizontal support beams (22-B) may include apertures (not shown) for slidably receiving a sprinkler support member (34) there through and multiple sprinkler support members (34) are fixedly attached in place by bolts and nuts, (not shown), or the like. Also, each of the multiple sprinkler support members (34) are removably yet fixedly attached by suitable attachment means, such as threads (not shown) to an elongated fluid containment housing (38), which is removably connected to an external fluid source and is used for providing fluid to each of the sprinklers (36). It is to be noted any suitable type of sprinkler (36) of engineering choice may be used. Also sprinkler (36) should be of a variety which provides either a drip, spray or mist, depending on user choice.

It is to be also understood that system (10) also includes propulsion means of engineering choice. For example, the fluid may be pressurized and used to propel the system (10) along a pre-determined path. Or the system may be motorized, or manually operated. However, such technology exists and is thus not taught within the present specification.

It is to be further understood that system (10) can be of any suitable size of engineering choice, as it may be used for a typical small garden, or it may be used for a football field, or the like.

The system (10) as heretofore described is functional for general purposes. However, depending on the user's preferences the system (10) may further include some variables. Such as the grow lights (30) may be solar powered. The fluid containment housing (38) may also be used for dispersing additional substances, such as fertilizer or pesticides. Or still further, the system (10) may include a lightweight spool of protective covering (40), such as plastic, which may be used as a cover for the vegetation either during or after treatment of the vegetation.

It is to be understood each of the components that make up the system (10), namely, multiple legs (12), support leg housing (14), horizontal support beams (22), multiple light support members (26), and multiple sprinkler support members (34) are each made from any suitable material of engineering choice, such as steel tubing, plastic, Nylon, etc.

It is to be further understood each of the above noted components may be color-coded for easy assembly.

It will now be seen we have herein provided a portable growth system which has unique features heretofore not taught within the prior art. Such as the system is completely portable, includes grow lights which may be connected to electrical power or they may be solar powered, the fluid conduit housing may be used to provide additional substances, it may include a protective covering used for vegetation, the components may be color-coded for easy assembly, and it is not limited to either indoor or outdoor use, or day or night use.

Also, a very important alternative feature of the present system (10) is to include multiple panels (42) which may be individually installed on top of system (10) and in combination function as a stage. Therefore, a performance such as a concert, stage production, etc. may be presented on top of the panels (42) while system (10) continues to function. It is to be noted any suitable panels (42) of engineering choice may be used. However, they are preferably easily interconnected, strong, portable and may be color-coded for easy assembly.

Although the invention has been herein shown and described in what is conceived to be the most practical and preferred embodiment, it is recognized that departures may be made there from within the scope and spirit of the invention, which is not to be limited to the details disclosed herein but is to be accorded the full scope of the claims so as to embrace any and all equivalent devices and apparatus's.

What we claim as new and wish to secure by Letters Patent is:

1. A portable accelerated growth system for vegetation comprising: a framework which is formed from multiple upright support legs; side horizontal support beams; cross horizontal support beams; multiple light support members; multiple grow lights; multiple sprinkler support beams; multiple sprinklers; and an elongated fluid containment housing; said multiple upright support legs being removably attached to said horizontal support beams, said horizontal support beams and said cross horizontal support beams being removably interconnected together, said cross horizontal support beams being removably attached to said multiple light support members, said multiple light support members having an electrical conduit therein for electrically connecting in series said multiple grow lights, said conduit being electrically connected to an external power source, said multiple sprinkler support members being removably attached to said elongated fluid containment housing, and said elongated fluid containment housing being removably connected to an external fluid source for providing fluid to said sprinklers.

2. The system of claim 1 wherein said multiple upright support legs are formed from a top section and a bottom section, each said section being slidably engaged within a support leg housing, and each said section and said support leg housing being removably adjustably attached together,
whereby:
said multiple upright support legs are variably adjustable in height.

3. The system of claim 2 wherein said bottom section further includes a wheel assembly thereon.

4. The system of claim 1 wherein said horizontal support beams and said cross horizontal support beams are removably interconnected together by a pivot which allows said framework to be assembled into various configurations.

5. The system of claim 1 wherein said multiple grow lights are rotateably mounted.

6. The system of claim 1 wherein said multiple grow lights each further include variable adjustable height means which allows said multiple grow lights to be individually lowered or raised.

7. The system of claim 1 wherein said elongated fluid containment housing is used for dispersing additional substances including fertilizer or pesticides.

8. The system of claim 1 further includes a lightweight spool of protective covering.

9. The system of claim 1 further includes each of the components which form said framework being color-coded for easy assembly.

10. The system of claim 1 further includes propulsion means.

11. The system of claim 1 further includes multiple panels which are individually installed on top of said system and in combination function as a stage,
whereby:
a stage production may be presented on top of said panels while said system continues to function.

12. A portable accelerated growth system for vegetation comprising: a framework which is formed from multiple upright support legs; side horizontal support beams; cross horizontal support beams; multiple light support members; multiple solar powered grow lights; multiple sprinkler support beams; multiple sprinklers; and an elongated fluid containment housing; said multiple upright support legs being removably attached to said horizontal support beams, said horizontal support beams and said cross horizontal support beams being removably interconnected together, said cross horizontal support beams being removably attached to said multiple light support members, said multiple sprinkler support members being removably attached to said elongated fluid containment housing, and said elongated fluid containment housing being removably connected to an external fluid source for providing fluid to said sprinklers.
